(19) United States
(12) Patent Application Publication
(10) Pub. No.: US 2015/0187130 A1
(43) Pub. Date: Jul. 2, 2015

(54) Automatic Generation of 2.5D Extruded Polygons from Full 3D Models

(71) Applicants: Igor Guskov, Ann Arbor, MI (US); Brian Brewington, Fort Collins, CO (US)

(72) Inventors: Igor Guskov, Ann Arbor, MI (US); Brian Brewington, Fort Collins, CO (US)

(73) Assignee: Google Inc., Mountain View, CA (US)

(21) Appl. No.: 13/024,855

(22) Filed: Feb. 10, 2011

(51) Int. Cl. G06T 17/00; G06T 17/20

(52) U.S. Cl. CPC G06T 17/00; G06T 17/20

(57) ABSTRACT

A capability to automatically generate a two-and-a-half-dimensional (2.5D) model from a three-dimensional (3D) model comprising a mesh of polygons representing a plurality of objects in a three-dimensional environment is provided. Such a two-and-a-half-dimensional model includes a set of extruded polygons (e.g., right prisms), each of which can have multiple shells (e.g., outer loops) and holes (e.g., inner loops). Such a group of shells and holes defines a volume in space according to its position relative to a reference plane. Namely, the volume is defined by a base height from which extrusion begins and an extrusion distance. This capability can be applied to any 3D model, including but not limited to, 3D building models.

### BACKGROUND

1. Field

Embodiments relate generally to the field of computer graphics.

2. Background

Dense urban areas present a challenge for three-dimensional (3D) level-of-detail representations that consider each 3D model individually. For example, a 3D model may represent an entire city block comprising numerous 3D building models. If a coarse representation of such a 3D model is maintained, then during rendering, the 3D model may need to be sub-divided into multiple 3D objects (e.g., multiple 3D building models) within the 3D model, and a texture resolution may need to be individually determined for each 3D object. Determining a texture resolution for multiple 3D objects in a plurality of 3D models in real-time rendering applications can be a resource intensive and time-consuming operation. Therefore, it may be necessary to convert the 3D model into a less-detailed representation, for example, a simplified representation that is not a 3D model.

Conventional simplification techniques can be applied to 3D models to simplify such models to increase efficiency of rendering 3D models. However, such simplification techniques may still produce 3D models. Conventional techniques may fail to generate a simplified model that is not also a 3D model while also maintaining architectural fidelity of the real-world object being represented in the simplified model.

### BRIEF SUMMARY

Embodiments relate to automatically generating a two-and-a-half-dimensional model (2.5D) from a three-dimensional model comprising a mesh of polygons representing one or a plurality of real-world objects in a three-dimensional (3D) environment.

In an embodiment, it is determined whether a surface normal of each polygon in a mesh of polygons exceeds an angle of tolerance relative to a reference plane. The mesh of polygons may represent one or a plurality of objects in a three-dimensional environment. A plurality of polygons representing a surface of an object is selected from the mesh of polygons, in which the surface normal of each polygon in the plurality of polygons exceeds the angle of tolerance relative to the reference plane. A connectivity graph of polygons that have shared edges is constructed using the selected plurality of polygons. The constructed connectivity graph can then be used to identify connected components of the surface of the object. Each connected component can include one or more polygons. The polygon(s) of each connected component are transformed into a two-dimensional polygonal shape that represents a base portion of the object. A two-and-a-half dimensional representation of the object can then be generated using the two-dimensional polygonal shapes and a height associated with each of the connected components of the surface. The generated two-and-a-half dimensional representation of the object includes a set of extruded polygons having a volume in space defined by a base height from which extrusion begins and an extrusion distance based on the height associated with each of the connected components.

Embodiments may be implemented using hardware, firmware, software, or a combination thereof and may be implemented in one or more computer systems or other processing systems.

Further embodiments, features, and advantages of the present invention, as well as the structure and operation of the various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments are described, by way of example only, with reference to the accompanying drawings. In the drawings, like reference numbers may indicate identical or functionally similar elements. The drawing in which an element first appears is typically indicated by the leftmost digit or digits in the corresponding reference number.

FIG. 1 is a diagram of an exemplary distributed system suitable for practicing an embodiment.

FIG. 2 is a diagram illustrating an example of how a mapping service can be integrated with an image viewer for viewing two-and-a-half dimensional (2.5D) models, according to an embodiment.

FIG. 3 is a diagram of an exemplary 2.5D model generator for generating a 2.5D model from a three-dimensional model, according to an embodiment.

FIG. 4A illustrates an exemplary three-dimensional model, according to an embodiment.

FIG. 4B illustrates roof portions of an exemplary three-dimensional building model, according to an embodiment.

FIG. 4C illustrates a wall portion of an exemplary three-dimensional building model, according to an embodiment.

FIG. 4D illustrates an aerial view of an exemplary 2.5D representation of a building that may be generated from a full 3D model, according to an embodiment.

FIG. 5 is a process flow chart of an exemplary method for generating a 2.5D building model from a three-dimensional model, according to an embodiment.

FIG. 6 is a process flow chart of an exemplary method for geometrically simplifying a generated 2.5D model, according to an embodiment.

FIG. 7 is a diagram of an example computer system in which embodiments can be implemented.

FIGS. 8A and 8B illustrate exemplary 2.5D representations of buildings incorporated in a map view of a geographic area, according to an embodiment.

The accompanying drawings, which are incorporated herein and form part of the specification, illustrate the embodiments of present invention and, together with the description, further serve to explain the principles of the invention and to enable a person skilled in the relevant art(s) to make and use the invention.

### DETAILED DESCRIPTION

### Introduction

A capability to automatically generate a two-and-a-half-dimensional (2.5D) model from a three-dimensional (3D) model comprising a mesh of polygons representing one or more objects in a three-dimensional environment is provided. Such a two-and-a-half-dimensional model may include a set of extruded polygons (e.g., right prisms), each of which can have multiple shells (e.g., outer loops) and holes (e.g., inner loops). Such a group of shells and holes defines a volume in space according to its position relative to a reference plane. Namely, the volume is defined by a base height from which extrusion begins and an extrusion distance. This capability can be applied to any 3D model including, but not limited to, 3D building models.

While the present invention is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to effect such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The term “two-and-a-half dimensional” (or simply “2.5D”) is used herein to refer broadly and inclusively to any graphical representation of an object having a set of extruded polygons (e.g., right prisms) in geometrical space. Such a two-and-a-half-dimensional model can comprise a set of extruded polygons. The extruded polygons may be, for example, right prisms. In addition, each extruded polygon may have multiple shells and holes that define the polygon's volume in space according to its position relative to a reference plane. The shells may correspond to, for example, outer loops of each polygon, and the holes may correspond to, for example, inner loops of each polygon. Such a volume is further defined by a base height from which extrusion begins, and an extrusion distance.

### System Overview

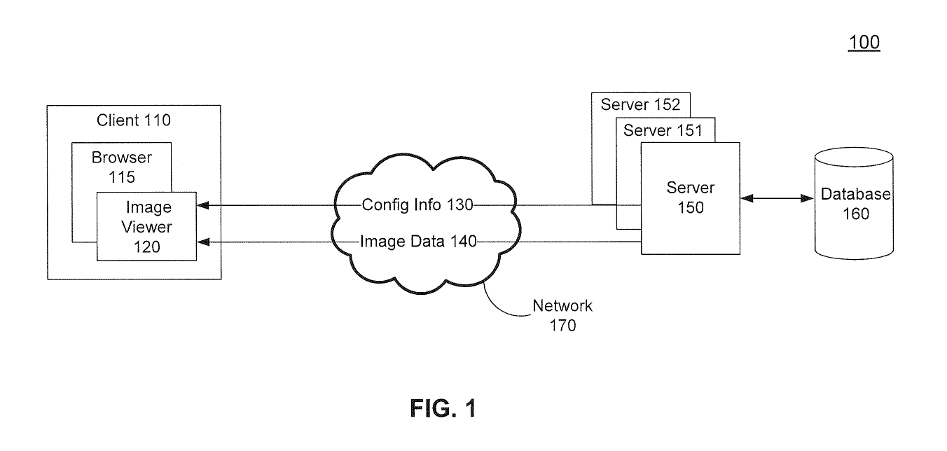

FIG. 1 is a diagram of an exemplary distributed system 100 suitable for practicing an embodiment. In the example shown in FIG. 1, system 100 includes a client 110, a browser 115, an image viewer 120, configuration information 130, image data 140, servers 150, 151, and 152, a database 160 and a network 170.

Client 110 communicates with one or more servers 150-152, for example, across network 170. Although only servers 150-152 are shown, more servers may be used as necessary. Network 170 can be any network or combination of networks that can carry data communication. Such network can include, but is not limited to, a local area network, medium area network, and/or wide area network such as the Internet. Client 110 can be a general-purpose computer with a processor, local memory, a display, and one or more input devices such as a keyboard or a mouse. Alternatively, client 110 can be a specialized computing device such as, for example, a mobile handset.

Similarly, servers 150-152 can be implemented using any general-purpose computer capable of serving data to client 110. In an embodiment, server(s) 150 are communicatively coupled to database 160. Database 160 may store any type of data (e.g., image data 140) accessible by server(s) 150. Although only database 160 is shown, more databases may be used as necessary.

Client 110 executes an image viewer 120, the operation of which is further described herein. Image viewer 120 may be implemented on any type of computing device. Such computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components. For example, the computing device may be a clustered computing environment or server farm.

As illustrated by FIG. 1, image viewer 120 requests configuration information 130 from server(s) 150. As discussed in further detail herein, the configuration information includes meta-information about an image to be loaded, including information on links within the image to other images. In an embodiment, the configuration information is presented in a form such as the Extensible Markup Language (XML). Image viewer 120 retrieves image data 140 for the image, for example, in the form of images or in the form of image tiles. In another embodiment, image data 140 includes the configuration information in the relevant file format.

The configuration information 130 and image data 140 can be used by image viewer 120 to generate a visual representation of the image and any additional user interface elements, as further described herein. In addition, such a visual representation and additional user interface elements may be presented to a user on a client display (not shown) communicatively coupled to client 110. Client display can be any type of electronic display for viewing images or can be any type of rendering device adapted to view three-dimensional images. As a user interacts with an input device to manipulate the visual representation of the image, image viewer 120 updates the visual representation and proceeds to download additional configuration information and images as needed.

In an embodiment, images retrieved and presented by image viewer 120 are 3D representations of various real-world objects associated with a geographical location. For example, 3D representations of buildings from a city block may be generated based on images of a major city taken by satellite at various angles. In a further embodiment, images retrieved and presented by image viewer 120 are 3D graphical models that can be presented on the client display. Such 3D models may be created by third-party data providers or other users. For example, a user may generate 3D models using 3D modeling software applications including, but not limited to, SKETCHUP and GOOGLE BUILDING MAKER from Google Inc. of Mountain View, Calif. Further, a single 3D model may represent a large geographic area, for example, an entire block of buildings in a city. Such a large 3D model may be referred to as a “full 3D model” herein. The 3D models or representations may be stored in a data repository or database accessible to client 110 and/or server(s) 150 over network 170. An example of such a data repository is the GOOGLE 3D WAREHOUSE, also from Google Inc. of Mountain View, Calif.

In an embodiment, image viewer 120 can be a standalone application, or it can be executed within a browser 115, for example and without limitation, GOOGLE CHROME from Google Inc. Image viewer 120, for example, can be executed as a script within browser 115, as a plug-in within browser 115, or as a program that executes within a browser plug-in, such as the ADOBE FLASH plug-in from Adobe Systems Inc. of San Jose, Calif. In an embodiment, image viewer 120 is integrated with a mapping service, such as the one described in U.S. Pat. No. 7,158,878, entitled “DIGITAL MAPPING SYSTEM,” which is incorporated by reference herein in its entirety.

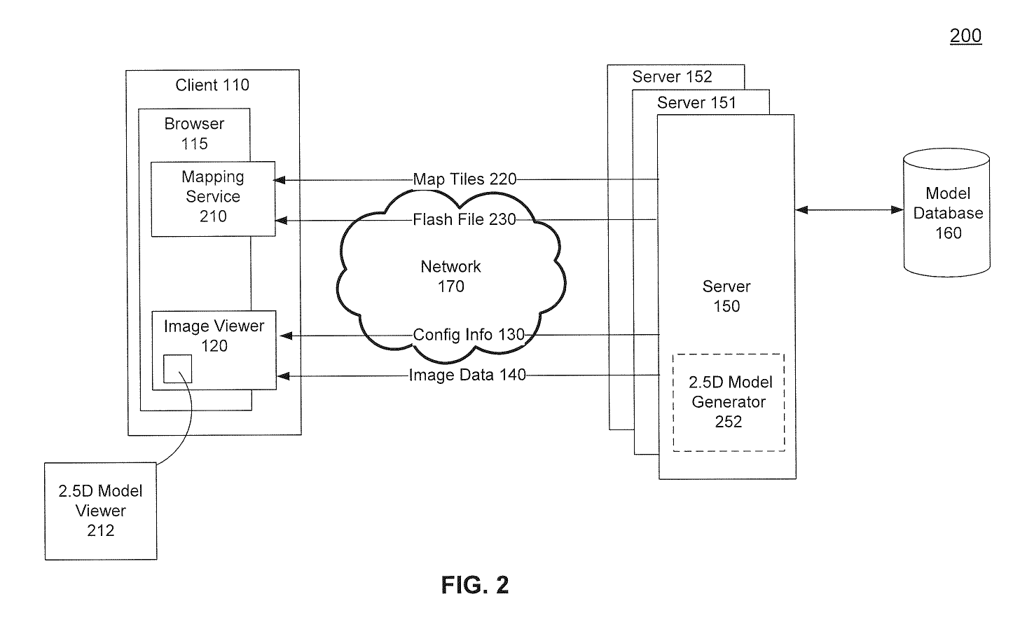

FIG. 2 is a diagram of a system 200 illustrating an example of how a mapping service can be integrated with an image viewer for viewing two-and-a-half dimensional (2.5D) models, according to an embodiment. In the example shown in FIG. 2, system 200 includes mapping service 210, a 2.5D model viewer 212, map tiles 220, flash file 230, and a 2.5D model generator 252.

Mapping service 210 displays a visual representation of a map, e.g., as a viewport into a grid of map tiles. Mapping service 210 can be implemented using any combination of markup and scripting elements, e.g., using HTML and Javascript. As the viewport is moved, mapping service 210 requests additional map tiles 220 from server(s) 150, assuming the requested map tiles have not already been cached in local cache memory. Notably, the server(s) which serve map tiles 220 can be the same or different server(s) from the server(s) which serve image data 140 or the other data involved herein.

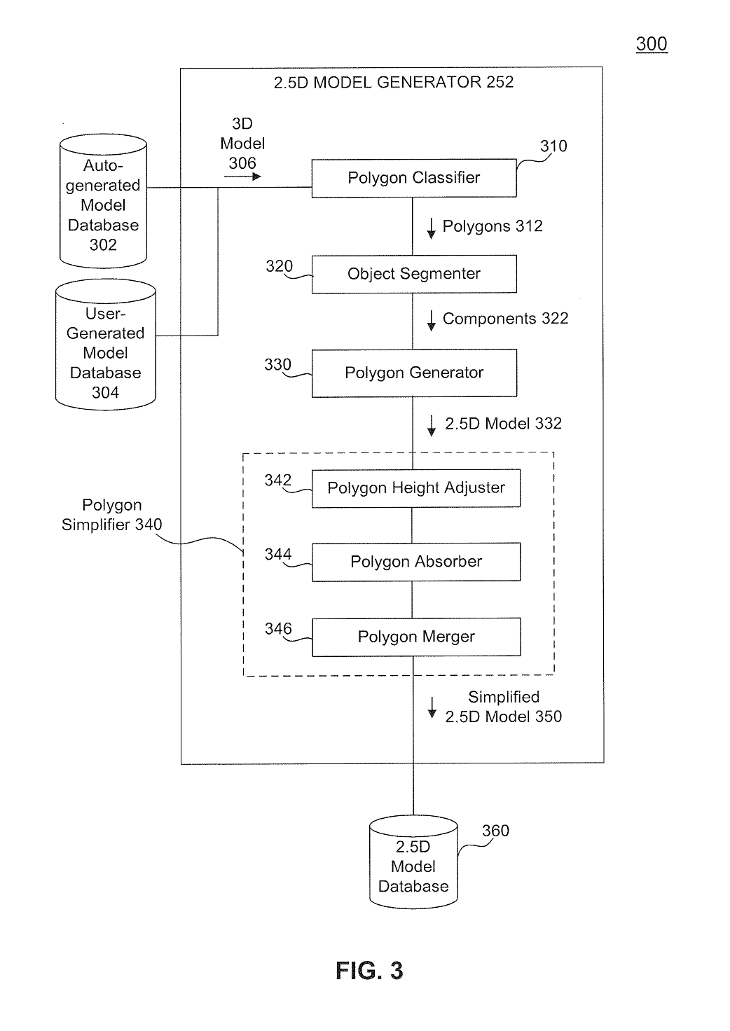

In an embodiment, image viewer 120 includes 2.5D model viewer 212 adapted to present a visual representation of a 2.5D model, as described herein, using a client display coupled to client 110, as described above. It is noted that while 2.5D model viewer 212 is shown in FIG. 2 as a separate component of image viewer 120, 2.5D model viewer 212 may be integrated within image viewer 120. Moreover, image viewer 120 may be configured to present the visual representation of the 2.5D model with or without using another image viewer. In an embodiment, image data 140 includes 2.5D models to be presented by image viewer 120 and/or 2.5D model viewer 212. In an embodiment, such 2.5D models may be automatically generated by 2.5D model generator 252, as will be described below with respect to FIG. 3.

In an embodiment, mapping service 210 can request that browser 115 proceed to download a flash file 230 for image viewer 120 from server(s) 150 and to instantiate any plug-in necessary to run flash file 230. Flash file 230 may be any software program or other form of executable content. Image viewer 120 executes and operates as described above. In addition, configuration information 130 and even image data 140, including automatically generated 2.5D models, can be retrieved by mapping service 210 and passed to image viewer 120. Image viewer 120 and mapping service 210 communicate so as to coordinate the operation of the user interface elements, to allow the user to interact with either image viewer 120 or mapping service 210, and to have the change in location or orientation reflected in both.

As described above, embodiments of the present invention can be operated according to a client-server configuration. However, it is noted that embodiments are not limited thereto and may be configured to operate solely at the client, with configuration information 130, image data 140, and map tiles 220 available at the client. For example, configuration information 130, image data 140, and map tiles 220 may be stored in a storage medium accessible by client 110, such as a CD-ROM or hard drive, for example. Accordingly, no communication with server(s) 150 would be needed.

### Automatic Generation of 2.5D Models

As mentioned previously, server(s) 150 can include 2.5D model generator 252 (or simply “model generator 252”). FIG. 3 is a diagram of an exemplary 2.5D model generator 252 for automatically generating a 2.5D model from a full 3D model, according to an embodiment. Model generator 252 includes a polygon classifier 310, an object segmenter 320, and a polygon generator 330. In an embodiment, model generator 252 also includes a polygon simplifier 340. In an embodiment, polygon simplifier 340 includes a polygon height adjuster 342, a polygon absorber 344, and a polygon merger 346.

In an embodiment, 3D model 306 comprises a mesh of polygons (e.g., triangles) representing, for example, one or more real-world objects. As described above, 3D model 306 may be a full 3D model representing objects associated with a geographic area. For example, such a full 3D model may be used to represent city blocks in a geographic information system (GIS). Such a GIS may be any type of system that presents data, including graphical models, in a three-dimensional environment. Further, the GIS can be used to store, retrieve, manipulate, and display a 3D model of real-world objects. As described above, 3D model 306 may be created by third-party data providers and/or other users. Accordingly, 3D model 306 can be stored in an auto-generated model database 302 or a user-generated model database 304. Auto-generated model database 302 and user-generated model database 304 may be any data repository or database (e.g., GOOGLE 3D WAREHOUSE from Google Inc. of Mountain View, Calif.) accessible to model generator 252 over a network (e.g., network 170 of FIGS. 1 and 2, as described above).

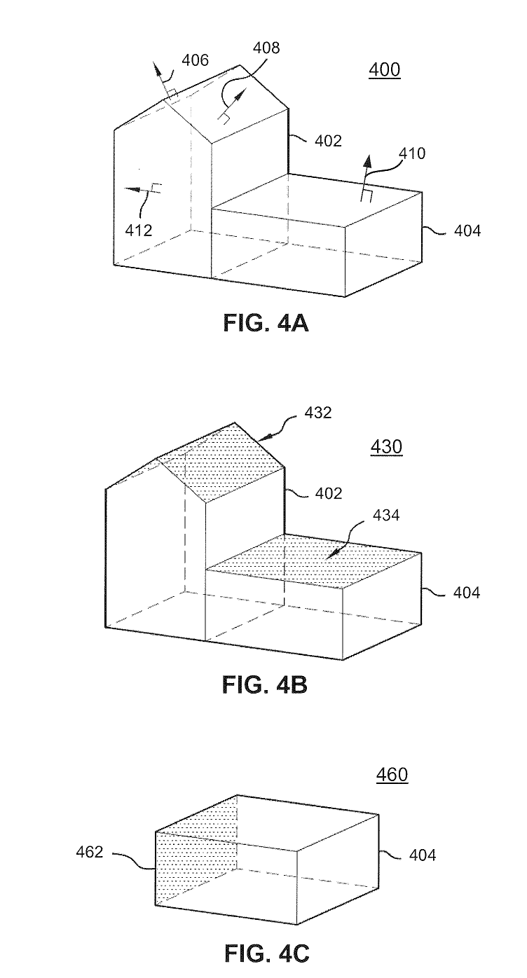

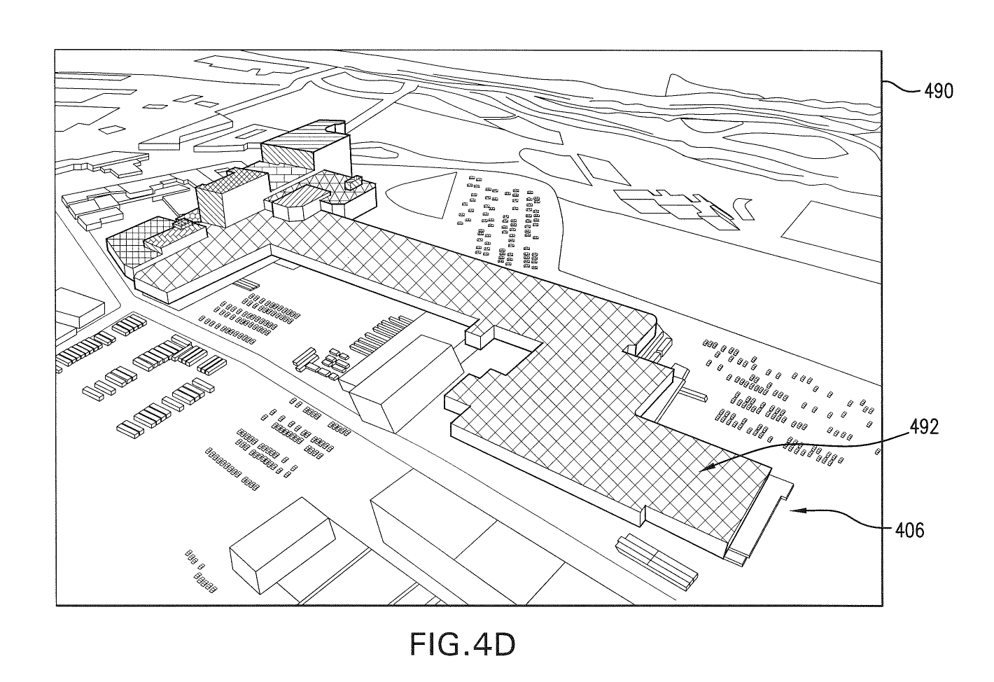

In an embodiment, polygon classifier 310 receives 3D model 306 and other 3D models from auto-generated model database 302 and/or user-generated model database 304. Polygon classifier 310 can then classify each polygon in the mesh of polygons of 3D model 306 into separate groups based on, for example, the position of the polygon in 3D space. In an example, polygon classifier 310 may classify each polygon of 3D model 306 as corresponding to either a top surface or side surface of an object being represented in 3D model 306 (e.g., a roof or wall of a building, as in the examples shown in FIGS. 4A-4C, described in further detail below).

In an embodiment, polygon classifier 310 classifies each polygon based on an angle of the surface normal vector (or simply “surface normal”) of a surface of the polygon relative to a reference plane in the 3D space. In an embodiment, polygon classifier 310 classifies a polygon as being associated with a top surface of an object represented in 3D model 306 if polygon classifier 310 determines the surface normal associated with a surface of the polygon exceeds a predetermined angle of tolerance relative to the reference plane. An example of such a reference plane includes, but is not limited to, a horizontal reference plane. A person skilled in the relevant art given this description would appreciate that any reference plane may be used.

Once the polygons of 3D model 306 are classified into separate groups, polygon classifier 310 may discard any groups of polygons not associated with the top surface of the object and send the remaining group of polygons, as shown by polygons 312 in FIG. 3, to object segmenter 320, described below. For example, if the object is a building model (see, e.g., building model 400 of FIG. 4A, described below), the top surface may correspond to the roof of the building, and polygon classifier 310 may classify the polygons as either roof polygons or wall polygons. Thus, in this example, polygon classifier 310 may discard the group of wall polygons and send the group of roof polygons as polygons 312 to object segmenter 320.

In an embodiment, object segmenter 320 constructs a connectivity graph of polygons using polygons 312 from polygon classifier 310. As discussed above, polygons 312 have shared edges and represent a top surface or surfaces of an object or objects represented in 3D model 306. It would be apparent to a person skilled in the relevant art that any of various well-known methods may be used by object segmenter 320 to construct such a connectivity graph of polygons.

In an embodiment, object segmenter 320 uses the constructed connectivity graph to identify connected components 322 of the top surface of the object. For example, object segmenter 320 may perform a connected component analysis of the polygons using the constructed connectivity graph. In this regard, object segmenter 320 can further group the polygons of the object's top surface into one or more components representing the various components or parts of the top surface. Accordingly, each component of the top surface identified by object segmenter 320 may be composed of one or more component polygons (e.g., triangles representing each connected component of the top surface).

In the building example discussed above and described in further detail below with respect to FIGS. 4A-4C, the top surface may correspond to the roof of a building model (e.g., building model 400 of FIG. 4A, described below). Accordingly, roof polygons (e.g., triangles having shared undirected edges) representing the roof of the building may be divided into roof components based on the connectivity graph, where each roof component may comprise one or more roof polygons.

In an embodiment, polygon generator 330 transforms the one or more component polygons of each identified component in components 322 into a two-dimensional polygonal shape representing a base portion of the object being represented. In an embodiment, polygon generator 330 projects the one or more component polygons for each component of the top surface of the object onto a two-dimensional plane, and then merges the projected component polygons into the two-dimensional polygonal shape. For example, the polygons within each identified component may be merged into a single footprint polygon that represents the base portion of the object. Such a footprint polygon may have holes or inner loops depending on the structure and type of object being represented by 3D model 306.

It would be apparent to a person skilled in the art given this description that polygon generator 330 may use any one of various well-known methods for processing and/or modeling geometry to merge the component polygons into the footprint polygon. One example of such a method includes, but is not limited to, using various polygon functions provided by the Computational Geometry Algorithms Library (CGAL), an open source software library from the CGAL Open Source Project.

In an embodiment, polygon generator 330 generates 2.5D model 332, a 2.5D representation of the object represented in the original 3D model 306. As described above, such a 2.5D representation comprises a set of extruded polygons (e.g., right prisms). Also as described above, each extruded polygon in the set can have multiple shells (e.g., outer loops) and holes (e.g., inner loops). Further, the volume in space of each extruded polygon can be defined by a base height from which extrusion begins, and an extrusion distance associated with the representation of the object in space. In an embodiment, the height of the two-dimensional polygonal shape is based on a height associated with each identified component of the top surface of the object and an extrusion distance associated with the object. In an embodiment, polygon generator 330 computes an average polygon height of every identified component and assigns the computed height as the height of the component.

In an embodiment, the 2.5D model 332 generated by polygon generator 330 can be further simplified by polygon simplifier 340. As mentioned previously, polygon simplifier 340 includes polygon height adjuster 342, polygon absorber 344, and polygon merger 346. Although not shown in FIG. 3, polygon simplifier 340 can include additional components as may be necessary for cleaning up or simplifying polygon geometry. As will be described in further detail below, polygon simplifier 340 can be configured to perform a polygon simplification or clean-up procedure on 2.5D model 332 to produce simplified 2.5D model 350. Simplified 2.5D model 350 may be stored for later retrieval at, for example, 2.5D model database 360. Referring back to FIG. 2, 2.5D model database 360 may be, for example, a standalone database communicatively coupled to 2.5D model generator 252 and/or server(s) 150 via network 170. Alternatively, 2.5D model database 360 may be any type of storage medium for storing data, including computer-generated graphic models (e.g., 2.5D model 332 and simplified 2.5D model 350), accessible to server(s) 150.

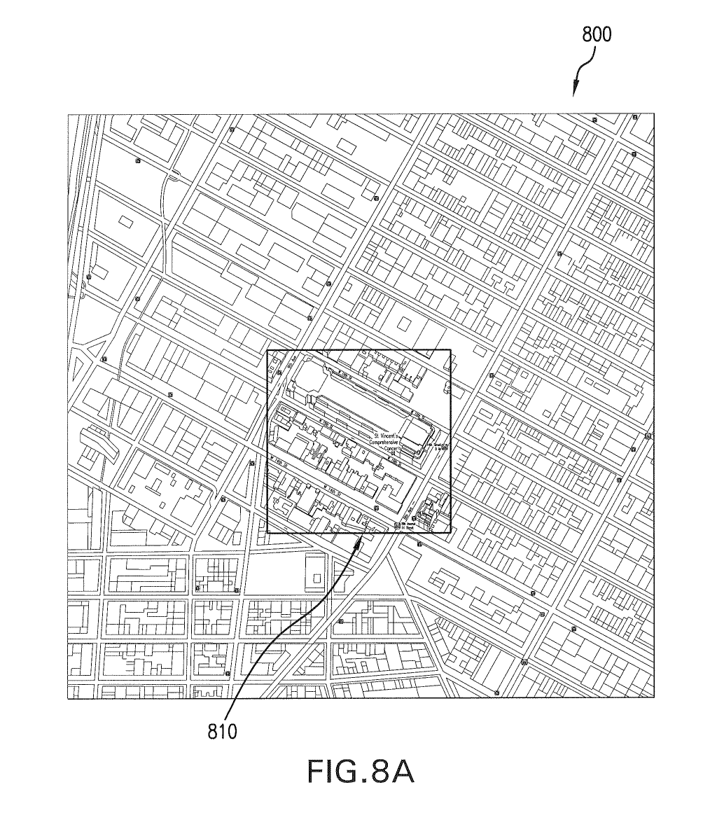

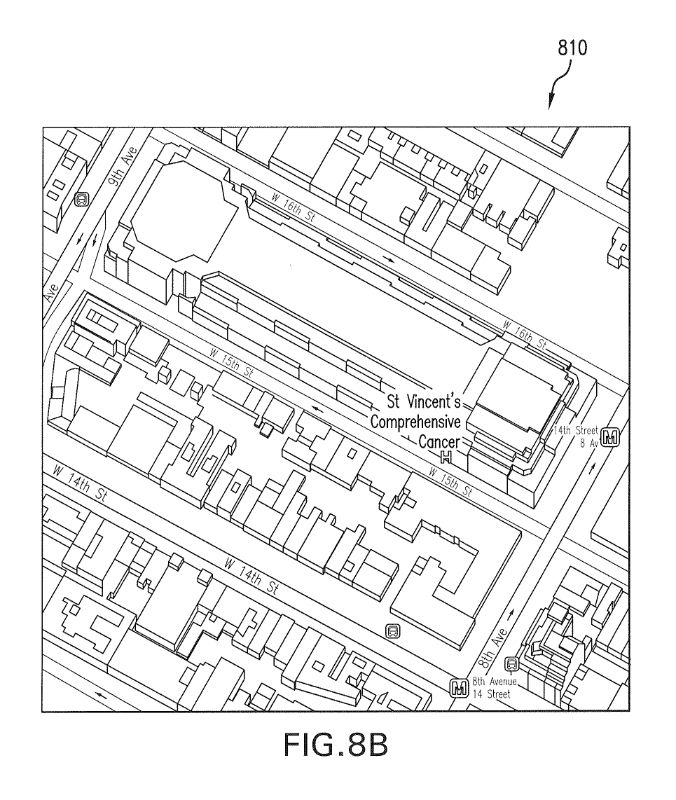

In an embodiment, polygon simplifier 340 assigns the two-and-a-half-dimensional representation of the object (i.e., 2.5D model 332) to a resolution level. In an example, the object being represented by 2.5D model 332 may be a map feature associated with a geographic location. In an embodiment, the 2.5D model may be displayed with a map as an overlay. In a further embodiment, the 2.5D model may be incorporated into the map tile image itself, as illustrated in FIGS. 8A and 8B. FIG. 8A illustrates exemplary 2.5D representations of buildings incorporated in a map view 800 of a geographic area, according to an embodiment. FIG. 8B presents a magnified version of the 2.5D building representations/models corresponding to the portion of map view 800 delineated by box 810 of map view 800.

Thus, the desired resolution level may be selected from a plurality of resolution levels of a geospatial data structure. An example of such a geospatial data structure is a quad tree having various nodes corresponding to various resolution levels or levels of detail. Further, each node of such a quad tree may correspond to a different zoom level for viewing the map feature being represented. Additional characteristics regarding the use and operation of such a geospatial quad tree data structure by polygon simplifier 340 would be apparent to a person skilled in the relevant art given this description. It would also be apparent to a person skilled in the relevant art given this description that polygon simplifier 340 may perform additional processing on the polygons of 2.5D model 332 prior to performing any simplification. For example, the polygons may be converted from one format to another prior to any simplification or clean up procedure.

In an embodiment, polygon simplifier 340 performs geometric simplification on the two-dimensional polygonal shape corresponding to each component of the top surface of the object represented by 2.5D model 332 based on the assigned resolution level of 2.5D model 332. The resolution level may be assigned, for example, according to a particular zoom level used to view the object in a viewport. The resolution level may also be assigned based on the height of the object relative to other nearby objects.

A few examples of such simplification procedures will be described below with respect to polygon height adjuster 342, polygon absorber 344, and polygon merger 346. However it is noted that embodiments are not limited to the examples described below. It would be apparent to a person skilled in the relevant art given this description that polygon simplifier 340 can apply any one of various types of simplification procedures to the polygons of 2.5D model 332.

One example of a type of simplification is adjusting the base height of the top surface of the object being represented in 2.5D model 332. In an embodiment, polygon height adjuster 342 adjusts the base height of the two-dimensional polygonal shape corresponding to each component of the top surface of the object represented by 2.5D model 332 so as to match the lowest height of the top surface of the object. For example, the base height for the top surface of the object in 2.5D model 332 may be adjusted by polygon height adjuster 342 so as to match the height of the adjacent component having the lowest height.

In addition to height adjustments performed by polygon height adjuster 342, polygon absorber 344 can perform additional operations to further simplify or “clean” polygons of 2.5D model 332. In an embodiment, polygon absorber 344 absorbs smaller polygons into nearby larger polygons containing the smaller polygons. For instance, in the above-described building example, polygons representing smaller building structures (e.g., a chimney stacks, exhaust ventilators, and/or towers) on the roof of a building may be absorbed into a larger container polygon representing another component of the roof. In an embodiment, polygon absorber absorbs smaller polygons by determining a relative size and proximity of the two-dimensional polygonal shape corresponding to each component of the top surface in 2.5D model 332. Polygon absorber 344 can then use the determined relative sizes and proximity values associated with the components to merge different two-dimensional polygonal shapes corresponding to different components.

A further simplification that can be applied to the polygons of 2.5D model 332 involves modifying the heights associated with components of the top surface so that they fall into a smaller set of values. The polygons having the same resulting height can then be merged. In an embodiment, polygon merger 346 quantizes the height of the two-dimensional polygonal shape corresponding to each component in order to reduce the respective height values of the components. Polygon merger 346 can then merge two-dimensional polygonal shapes corresponding to the components based on the quantized height of the two-dimensional polygonal shape corresponding to each component. In a further embodiment, polygon merger 346 merges the two-dimensional polygonal shapes corresponding to the components according to the base and structure of each two-dimensional polygonal shape. For example, polygon merger 346 may quantize both base and structure heights, then group the polygons to be merged based on the resulting values. Each group may include polygons having the same base height as well as the same structure height.

### Example Building Models

FIGS. 4A-4C illustrate various example 3D building models 400, 430, and 460, in accordance with embodiments. For example, one or more of building models 400, 430, and 460 may be included in 3D model 306 of FIG. 3, as described above. It is noted that embodiments are described with respect to 3D building models for ease of explanation and illustrative purposes, but embodiments are not intended to be limited thereto. It would be apparent to a person skilled in the relevant art given the description herein that embodiments may be applied to any 3D model.

FIG. 4A illustrates a 3D model 400 comprising different buildings, according to an embodiment. In the example illustrated in FIG. 4A, 3D model 400 includes a 3D building 402 and a 3D building 404. Further, a surface normal 406, a surface normal 408, and a surface normal 412 are surface normal vectors shown for three different polygons associated with different portions of 3D building 402.

In an embodiment, the different types of polygons may be delineated by polygon classifier 310 based on an angle of the surface normal of each polygon relative to a reference plane, as noted above. For example, polygons associated with a wall of 3D building 402 (or “wall polygons”) may be polygons for which the surface normal is within some angle of tolerance relative to a reference plane. Conversely, polygons associated with a roof of 3D building 402 (or “roof polygons”) may be polygons for which the surface normal exceeds a predetermined angle of tolerance relative to the same reference plane. For ease of explanation and illustrative purposes, it is assumed that the reference plane is horizontal.

Thus, referring back to FIG. 3, for example, it may be determined by polygon classifier 310 that surface normal 406 and surface normal 408 exceed some angle of tolerance relative to the reference plane. Accordingly, polygon classifier 310 can classify the polygons corresponding to surface normal 406 and surface normal 408 as roof polygons for 3D building 402. On the other hand, surface normal 412, which appears to be substantially vertical relative to the reference plane, may be determined to be within the angle of tolerance relative to the reference plane, the polygon corresponding to surface normal 112 would be classified as a wall polygon for 3D building 402.

As described above, identified roof polygons can be used to construct a connectivity graph, which in turn, can be used to identify connected roof components for a particular roof or roofs of buildings that are being represented in the 3D model. For example, each roof component for a particular roof may include two or more roof polygons that share edges. If roof polygons have discontinuous edges, the polygons are likely part of two separate roofs and would be part of separate roof meshes. In an embodiment, the roof components may be a continuous mesh of polygons where each roof polygon shares at least one edge, and the perimeter of the mesh is defined as one or more edges that are not connected to any other roof polygon.

FIG. 4B is a continued representation of buildings 402 and 404. Surface 432, indicated by shading, is a roof surface. Referring back to FIG. 4A, roof 432 may be derived by analyzing the angles of surface normal 406 and surface normal 408, as described above. Further, since the two surfaces corresponding to each surface normal vector share an edge, they may correspond to the same building. Similarly, surface 434, identified by surface normal 410, is a roof surface corresponding to building 404.

FIG. 4C is a continued representation of building 404. Surface 462, indicated by shading, is a vertical surface that may overlap with a separate building, in this case, building 402. Although not illustrated in FIG. 4C, the surface normal of surface 462 would likely be substantially horizontal relative to the reference plane and therefore, be well within an angle of tolerance relative to the reference plane. Accordingly, the polygon corresponding to surface 462 would be classified as a wall polygon.

FIG. 4D illustrates an aerial view 490 of an exemplary 2.5D representation of a building 406 that may be generated from a full 3D model, according to an embodiment. For example, a building model corresponding to building 406 may be included in a full 3D model. In an embodiment, such a building model may be automatically subdivided into adjacent roof components or roof areas corresponding to roof 492 in order to generate the 2.5D representation, as illustrated in FIG. 4D.

### Method

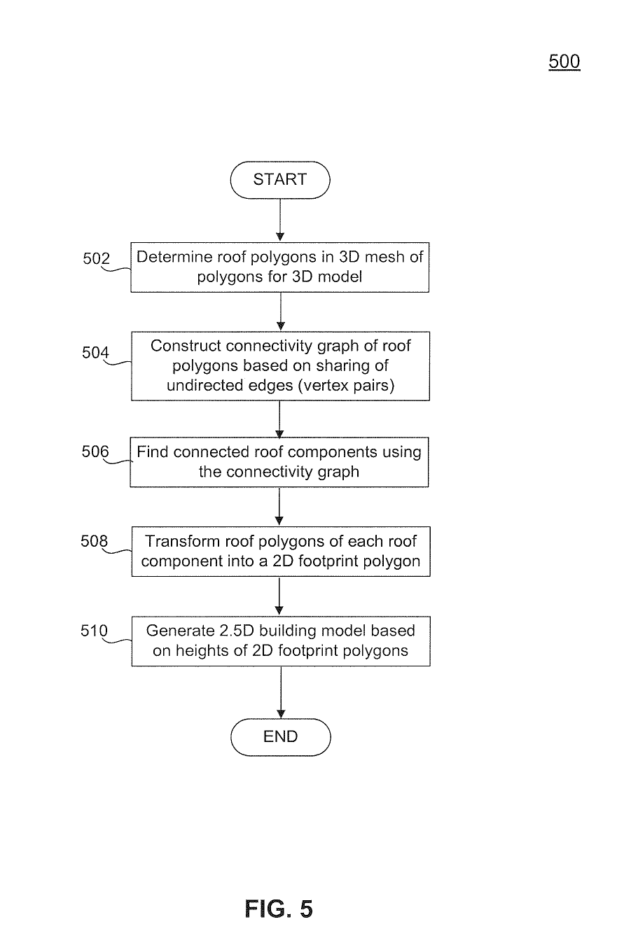

FIG. 5 is a process flow chart of an exemplary method 500 for generating 2.5D building models from full 3D models, according to an embodiment. For ease of explanation, method 500 will be described using 2.5D model generator 252 of FIGS. 2 and 3, as described above. However, it is noted that this method is not intended to be limited thereto. Further, for ease of explanation, method 500 will be described using the building model examples illustrated in FIGS. 4A-4C and described above, but is not intended to be limited thereto.

Method 500 begins in step 502, which includes determining whether each polygon in a 3D mesh of polygons associated with a 3D model correspond to roof polygons. For example, the 3D model may include one or several models of buildings associated with a city block, as previously discussed. The polygons may be, for example, classified as either roof polygons or wall polygons based on an angle of tolerance of a surface normal of the polygon relative to a reference plane. An example of such a reference plane includes, but is not limited to, a horizontal reference plane. Thus, a polygon may be classified as a roof polygon if, for example, the angle of tolerance of the surface normal of the polygon exceeds the angle of tolerance relative to the horizontal reference plane. In a different example, the reference plane may be a vertical reference plane, and the criteria used for the classification of polygons with respect to such a reference plane may be adjusted as necessary. Step 502 may be performed by, for example, polygon classifier 310 of FIG. 3, as described above.

Method 500 then proceeds to step 504, in which a connectivity graph of the identified roof polygons is constructed. The connectivity graph can be constructed by identifying roof polygons having shared undirected edges (vertex pairs). In step 506, the connectivity graph is used to find various components of the roof that are connected. Steps 504 and 506 may be performed by, for example, object segmenter 320 of FIG. 3, as described above.

Once the roof components have been identified in step 506, method 500 proceeds to step 508, which includes transforming the roof polygons of each identified roof component into a two-dimensional (2D) footprint polygon or 2D polygonal shape representing the footprint of the particular building being represented in the model. Such a 2D polygonal shape may, for example, have holes or inner loops based on the base and structure of the building. The transformations in step 508 can include projecting the component polygons of each roof component onto a 2D plane, and then merging the projected component polygons into a 2D polygonal shape representing the footprint of the building.

Method 500 concludes in step 510, in which a 2.5D building model is generated based on a computed height of each footprint polygon. The generated 2.5D building model can include a set of extruded polygons having a volume in space defined by multiple shells and holes, as described above. Further, the volume can be defined by a base height from which each polygon can be extruded according to an extrusion distance. Thus, step 510 may include, for example, computing an average polygon height for each roof component, and designating the computed average as the height of the particular roof component. The designated height associated with each roof component can then be used to generate the extruded polygons of the 2.5D building model. Steps 508 and 510 may be performed by, for example, polygon generator 330 of FIG. 3, as described above.

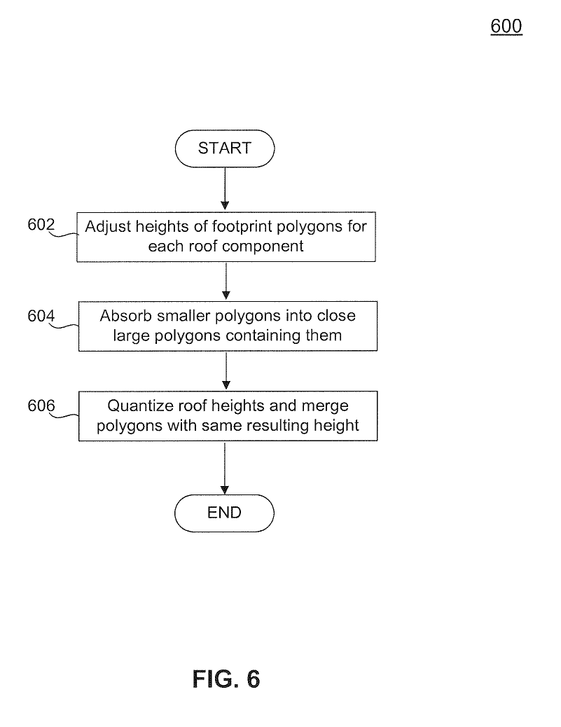

The generated 2.5D model in step 510 can be further simplified by performing one or more clean-up operations on the polygon geometry of the model, as will be described with respect to FIG. 6. FIG. 6 is a process flow chart of an exemplary method 600 for geometrically simplifying a generated 2.5D model, according to an embodiment. As noted above, method 600 may be applied, for example, to the 2.5D building model generated in step 510 of method 500. Like method 500, method 600 will be described using 2.5D model generator 252 of FIGS. 2 and 3 and the building model examples illustrated in FIGS. 4A-4C, as described above, but the method is not intended to be limited thereto.

Method 600 begins in step 602, in which heights of footprint polygons (e.g., generated in step 508 of method 500, as described above) are adjusted for each roof component. Step 602 can include adjusting the heights of contained polygons to match the lower height of roofs surrounding them. Step 602 can be performed by, for example, polygon height adjuster 342 of FIG. 3, as described above.

After heights are adjusted in step 602, method 600 can proceed to step 604, which includes absorbing relatively smaller polygons into nearby larger polygons containing them. As mentioned previously, the smaller polygons may represent relatively small roof structures including, but not limited to, chimneys, exhaust ventilators, and tower structures that are located on the roof of the building. Step 604 may include, for example, determining the relative size and proximity of the 2D footprint polygonal shape (or simply “2D footprint polygon,” generated in step 508 of method 500, as described above) corresponding to each roof component. Step 604 may further include merging different 2D footprint polygons corresponding to different roof components based on the relative sizes and proximity values for the 2D footprint polygons. Step 604 may be performed by, for example, polygon absorber 344 of FIG. 3, as described above.

Method 600 can then proceed to step 606, in which a further simplification can be applied to the 2.5D model (generated in step 510 of method 500, described above). Step 606 includes modifying the heights associated with the roof components so that they fall into a smaller set of values and merge the polygons with the same resulting height. Step 606 may include, for example, quantizing the height of the 2D footprint polygon corresponding to each roof component, and then merging 2D footprint polygons corresponding to different roof components based on the new quantized height values. Step 606 may be performed by, for example, polygon merger 346 of FIG. 3, as described above. It is noted that method 600 can conclude in step 606, or alternatively, can include additional steps for simplifying the 2.5D building model further, although not shown in FIG. 6. It would be apparent to a person of skill in the relevant art given this description that any number of additional well-known polygon simplification techniques may also be applied to the 2.5D building model to simplify it further.

Advantages of method 500 and method 600 include, but are not limited to, enabling the automatic generation of simplified 2.5D models from full 3D models, thereby increasing rendering efficiency and performance. For example, the simplified model would require less bandwidth and lower memory requirements than 3D models. Further, the automatic generation of 2.5D models as described herein provides the aforementioned advantages while also maintaining architectural fidelity of the object (e.g., building) being represented.

### Example Computer System

Aspects of the present invention shown in FIGS. 1-6, or any part(s) or function(s) thereof, may be implemented using hardware, software modules, firmware, tangible computer readable media having instructions stored thereon, or a combination thereof and may be implemented in one or more computer systems or other processing systems.

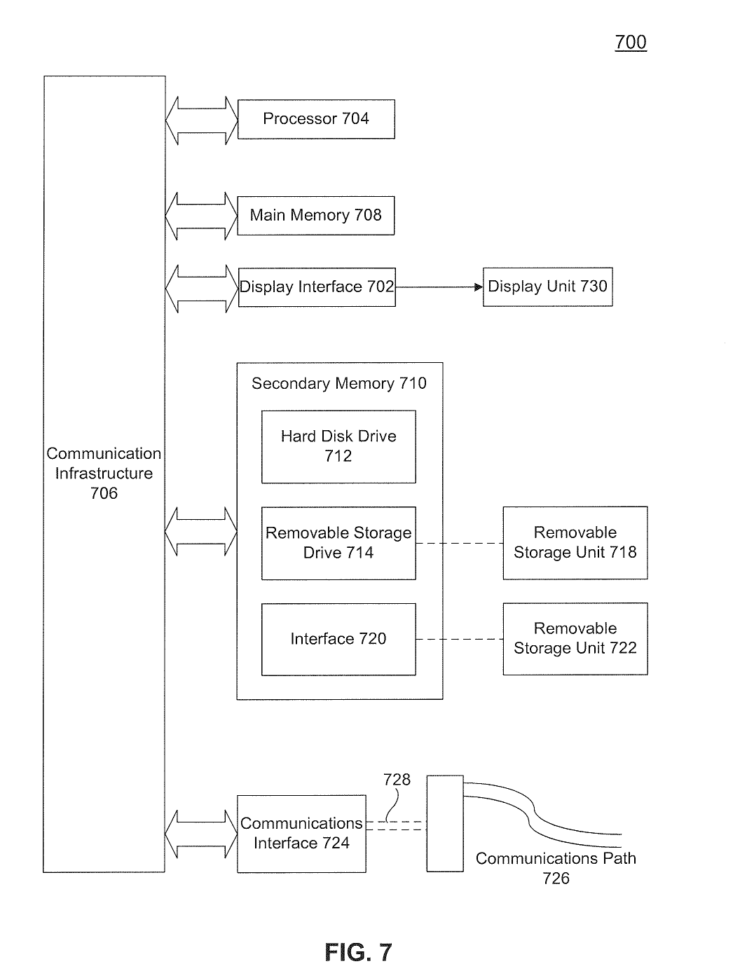

FIG. 7 illustrates an example computer system 700 in which embodiments of the present invention, or portions thereof, may be implemented as computer-readable code. For example, one or more components of system 100 of FIG. 1, system 200 of FIG. 2, and/or one or more components of 2.5D model generator 252 of FIGS. 2 and 3, can be implemented in computer system 700 using hardware, software, firmware, tangible computer readable media having instructions stored thereon, or a combination thereof and may be implemented in one or more computer systems or other processing systems. Hardware, software, or any combination of such may embody one or more of the modules and components in FIGS. 1-6.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 700. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. As will be appreciated by persons skilled in the relevant art, processor device 704 may also be a single processor in a multi-core/multiprocessor system, such system operating alone, or in a cluster of computing devices operating in a cluster or server faun. Processor device 704 is connected to a communication infrastructure 706, for example, a bus, message queue, network, or multi-core message-passing scheme.

Computer system 700 also includes a main memory 708, for example, random access memory (RAM), and may also include a secondary memory 710. Secondary memory 710 may include, for example, a hard disk drive 712, and removable storage drive 714. Removable storage drive 714 may comprise a floppy disk drive, a magnetic tape drive, an optical disk drive, a flash memory, or the like. The removable storage drive 714 reads from and/or writes to a removable storage unit 718 in a well known manner. Removable storage unit 718 may comprise a floppy disk, magnetic tape, optical disk, etc. which is read by and written to by removable storage drive 714. As will be appreciated by persons skilled in the relevant art, removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 may be in the form of signals, which may be electronic, electromagnetic, optical, or other signals capable of being received by communications interface 724. These signals may be provided to communications interface 724 via a communications path 726. Communications path 726 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, and a hard disk installed in hard disk drive 712. Computer program medium and computer usable medium may also refer to memories, such as main memory 708 and secondary memory 710, which may be memory semiconductors (e.g. DRAMs, etc.).

Computer programs (also called computer control logic) are stored in main memory 708 and/or secondary memory 710. Computer programs may also be received via communications interface 724. Such computer programs, when executed, enable computer system 700 to implement embodiments of the present invention as discussed herein. In particular, the computer programs, when executed, enable processor device 704 to implement the processes of embodiments, such as the stages in the methods illustrated by flowcharts 500 and 600 of FIG. 5 and FIG. 6, respectively, discussed above. Accordingly, such computer programs represent controllers of the computer system 700. Where embodiments are implemented using software, the software may be stored in a computer program product and loaded into computer system 700 using removable storage drive 714, interface 720, and hard disk drive 712, or communications interface 724.

Embodiments of the invention also may be directed to computer program products comprising software stored on any computer useable medium. Such software, when executed in one or more data processing devices, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### CONCLUSION

The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for automatic generation of two-and-a-half dimensional models from three-dimensional models the method comprising:
receiving data describing a three-dimensional model that includes a mesh of polygons representing at least one object in a three-dimensional environment;
selecting a plurality of polygons from the mesh of polygons representing a first surface of the object, wherein a surface normal of each polygon in the plurality of polygons exceeds an angle of tolerance relative to a reference plane;
constructing a connectivity graph of polygons in the selected plurality of polygons having shared edges, wherein the connectivity graph is used to identify connected components of the first surface, and each of the connected components includes one or more polygons in the selected plurality of polygons;
transforming the one or more polygons of each of the connected components into a two-dimensional polygonal shape representing a base portion of the object;
generating a two-and-a-half dimensional representation of the object based on the two-dimensional polygonal shape and a height associated with each of the connected components, the two-and-a-half dimensional representation including a set of extruded polygons having a volume in space relative to the reference plane, the volume in space defined by a base height from which extrusion begins and an extrusion distance based on the height associated with each of the connected components of the first surface;
mapping the height associated with each of the connected components into one of a predefined set of values; and
merging two-dimensional polygonal shapes corresponding to two or more connected components that are mapped to the same one of the predefined set of values to simplify the generated two-and-a-half dimensional representation of the object,
wherein the receiving, selecting, constructing, transforming, generating, mapping, and merging steps are performed via one or more processors of one or more computing devices.

2. The method of claim 1, wherein the three-dimensional model represents a plurality of objects, and the selecting, constructing, transforming, generating, mapping, and merging steps are performed for each object in the plurality of objects.

3. The method of claim 1, wherein the selecting step comprises:
identifying a first set of polygons in the mesh of polygons representing the first surface of the object, wherein the surface normal of each polygon in the first set exceeds the angle of tolerance relative to the reference plane;
identifying a second set of polygons in the mesh of polygons representing a second surface of the object, wherein the surface normal of each polygon in the second set is within the angle of tolerance relative to the reference plane; and
selecting the plurality of polygons based on the identified first set of polygons.

4. The method of claim 1, wherein the transforming step comprises:
projecting the one or more polygons of each of the connected components onto a two-dimensional plane; and
merging the projected one or more polygons to form the two-dimensional polygonal shape representing the base portion of the object.

5. The method of claim 1, wherein the generating step further comprises:
computing an average polygon height for each of the connected components of the first surface of the object; and
designating the computed average height as the height of each of the connected components.

6. The method of claim 1, further comprising:
performing one or more geometric simplification operations on the generated two-and-a-half dimensional representation of the object to create a simplified two-and-a-half dimensional representation of the object.

7. The method of claim 6, wherein the performing comprises:
converting the first set of extruded polygons of the two-and-a-half dimensional representation into a plurality of regular polygons; and
performing the one or more geometric simplification operations on the plurality of regular polygons to create the simplified two-and-a-half dimensional representation of the object.

8. The method of claim 6, wherein the performing step comprises:
adjusting a first extrusion distance of a first polygon in the set of extruded polygons so as to match a second extrusion distance of a second polygon in the set of extruded polygons, wherein the first polygon is contained within the second polygon, and the second extrusion distance is smaller than the first extrusion distance.

9. The method of claim 8, wherein the performing step further comprises:
determining a relative size and proximity of each extruded polygon in the set of extruded polygons corresponding to each of the connected components of the first surface of the object; and
merging two or more extruded polygons in the set of extruded polygons based on the determined relative size and proximity of each of the two or more extruded polygons, wherein relatively smaller-sized polygons are absorbed into relatively larger-sized polygons located in close proximity to the smaller-sized polygons.

10. (canceled)

11. The method of claim 1, wherein the merging the two-dimensional polygonal shapes further comprises:
merging the two-dimensional polygonal shapes corresponding to the two or more connected components based on a base and a structure of each of the two or more connected components.

12. A system for automatic generation of two-and-a-half-dimensional models from three-dimensional models comprising:
a polygon classifier to receive data describing a three-dimensional model that includes a mesh of polygons representing an object in a three-dimensional environment, the polygon classifier selecting a plurality of polygons from the mesh of polygons representing a first surface of the object, wherein a surface normal of each polygon in the plurality of polygons exceeds an angle of tolerance relative to a reference plane;
an object segmenter to construct a connectivity graph of polygons in the selected plurality of polygons having shared edges, wherein the connectivity graph is used to identify connected components of the first surface, and each of the connected components includes one or more polygons in the selected plurality of polygons;
a polygon generator to transform the one or more polygons of each of the connected components into a two-dimensional polygonal shape representing a base portion of the object, and to generate a two-and-a-half dimensional representation of the object based on the two-dimensional polygonal shape and a height associated with each of the connected components, the two-and-a-half dimensional representation including a set of extruded polygons having a volume in space relative to the reference plane, the volume in space defined by a base height from which extrusion begins and an extrusion distance based on the height associated with each of the connected components of the first surface; and
a polygon merger to map the height associated with each of the connected components into one of a predefined set of values, and to merge two-dimensional polygonal shapes corresponding to two or more connected components that are mapped to the same one of the predefined set of values to simplify the generated two-and-a-half dimensional representation of the object.

13. The system of claim 12, wherein the polygon classifier is configured to:
identify a first set of polygons in the mesh of polygons representing the first surface of the object, wherein the surface normal of each polygon in the first set exceeds the angle of tolerance relative to the reference plane;
identify a second set of polygons in the mesh of polygons representing a second surface of the object, wherein the surface normal of each polygon in the second set is within the angle of tolerance relative to the reference plane; and
select the plurality of polygons based on the first set of polygons.

14. The system of claim 12, wherein the polygon generator is configured to:
project the one or more component polygons for each connected component of the top surface of the object onto a two-dimensional plane, and
merge the projected one or more component polygons into the two-dimensional polygonal shape representing the base portion of the object.

15. The system of claim 12, wherein the polygon generator is configured to:
compute an average polygon height for each of the connected components of the first surface of the object; and
designate the computed average height as the height of each of the connected components.

16. The system of claim 12, further comprising:
a polygon simplifier to perform one or more geometric simplification operations on the generated two-and-a-half dimensional representation of the object to create a simplified two-and-a-half dimensional representation of the object.

17. The system of claim 16, wherein the polygon simplifier is further configured to:
convert the first set of extruded polygons of the two-and-a-half dimensional representation into a plurality of regular polygons; and
perform the one or more geometric simplification operations on the plurality of regular polygons to create the simplified two-and-a-half dimensional representation of the object.

18. The system of claim 16, wherein the polygon simplifier comprises:
a polygon height adjuster to adjust a first extrusion distance of a first polygon in the set of extruded polygons so as to match a second extrusion distance of a second polygon in the set of extruded polygons, wherein the first polygon is contained within the second polygon, and the second extrusion distance is smaller than the first extrusion distance.

19. The system of claim 18, wherein the polygon simplifier further comprises:
a polygon absorber to determine a relative size and proximity of each extruded polygon in the set of extruded polygons corresponding to each of the connected components of the first surface of the object, and to merge two or more extruded polygons in the set of extruded polygons based on the determined relative size and proximity of each of the two or more extruded polygons, wherein relatively smaller-sized polygons are absorbed into relatively larger-sized polygons located in close proximity to the smaller-sized polygons.

20. (canceled)

21. The system of claim 12, wherein the polygon merger is configured to merge the two-dimensional polygonal shapes corresponding to the two or more connected components based on a base and a structure of each of the two or more connected components.

22. A computer-implemented method for automatic generation of two-and-a-half-dimensional models from three-dimensional models comprising:
receiving data describing a three-dimensional model that includes a mesh of polygons representing a plurality of buildings in a three-dimensional environment;
determining whether each polygon in the mesh of polygons represents a roof portion for each building in the plurality of buildings according to a position of each polygon relative to a reference plane;
constructing a connectivity graph comprising a plurality of roof polygons having shared edges in the mesh of polygons based on the determining step, the roof polygons representing a roof of a building in the plurality of buildings;
identifying connected roof components of the roof based on the constructed connectivity graph, each roof component in the connected roof components having one or more roof polygons in the plurality of roof polygons;
transforming the one or more roof polygons of each roof component into a two-dimensional polygonal shape representing a footprint of the building;
generating a two-and-a-half dimensional representation of the building based on the two-dimensional polygonal shape and a height associated with each roof component, the two-and-a-half-dimensional representation including a set of extruded polygons having a volume in space relative to the reference plane, the volume in space defined by a base height from which extrusion begins and an extrusion distance based on the height associated with each roof component;
mapping the height associated with each roof component in the connected roof components into one of a predefined set of values; and
merging two-dimensional polygonal shapes corresponding to two or more connected roof components that are mapped to the same one of the predefined set of values to simplify the generated two-and-a-half dimensional representation of the building,
wherein the receiving, determining, constructing, identifying, transforming, generating, mapping, and merging steps are performed via one or more processors of one or more computing devices.
